(19) United States
(12) Patent Application Publication
(10) Pub. No.: US 2025/0257247 A1
(43) Pub. Date: Aug. 14, 2025

(54) DECORATIVE FILM

(71) Applicant: 3M INNOVATIVE PROPERTIES COMPANY, St. Paul, MN (US)

(72) Inventor: Hidetoshi Abe, Yamagata (JP)

(21) Appl. No.: 18/997,692

(22) PCT Filed: Aug. 3, 2023
(86) PCT No.: PCT/IB2023/057877

§ 371 Date: Jan. 22, 2025

(30) Foreign Application Priority Data
Aug. 24, 2022 (JP) 2022-133526

(51) Int. Cl. C09J 7/38; B32B 27/08; B32B 27/30; B32B 27/40; B44D 5/00

(52) U.S. Cl. CPC C09J 7/385; B32B 27/08; B32B 27/308; B32B 27/40; B44D 5/00; B32B 2250/24; B32B 2274/00; B32B 2307/306; B32B 2307/308; B32B 2307/4026; B32B 2307/412; B32B 2307/54; B32B 2307/7376; B32B 2307/748; B32B 2405/00; B32B 2451/00

(57) ABSTRACT

Provided is a polyurethane-based decorative film that combines multiple functions such as coloring and paint protection in a single product. Solution Means A decorative film according to an embodiment includes: a transparent top layer containing a transparent thermoplastic polyurethane elastomer film; and a colored acrylic pressure-sensitive adhesive layer. The decorative film has a tensile strength at 2% strain of 20 N/25 mm or less and an elongation of 150% or greater.

### TECHNICAL FIELD

The present disclosure relates to a decorative film.

### BACKGROUND ART

Colored decorative films have been widely used for interior and exterior applications in vehicles including automobiles, trains, ships, and other vehicles, as well as buildings. Colored decorative films are used at the time of, for example, production of vehicles or construction of buildings, or repairing of vehicles and buildings.

Car wrapping is a known application of decorative films. In car wrapping, the appearance of an automobile can be changed by applying a special decorative film to a body of the automobile. Polyvinyl chloride (PVC)-based colored films are generally used for car wrapping applications in order to allow a decorative film to be stretched and adhered even on surfaces with a large curvature.

Meanwhile, covering a part or all of the body of an automobile with a transparent film is known for the purpose of protecting the paint of the automobile from flying stones, scratches, etc. Transparent thermoplastic polyurethane elastomer films are suitably used as paint protection films because they have useful characteristics such as chipping resistance, scratch resistance, and self-healing properties.

Patent Document 1 (JP 2009-203370 A) discloses “a marking film including: a colored base film layer; and an adhesive layer including an acrylic white adhesive, the adhesive layer being laminated on the colored base film layer, where the acrylic white adhesive contains a carboxyl group-containing (meth)acrylic polymer, 25 to 150 parts by mass of a white pigment with respect to 100 parts by mass of the carboxyl group-containing (meth)acrylic polymer, and an amino group-containing (meth)acrylic polymer containing no aromatic vinyl monomer”.

Patent Document 2 (JP 2003-183602 A) discloses “an adhesive sheet for decorative use, which is characterized by including an adhesive agent containing from 3 to 50 parts by weight of a white pigment relative to 100 parts by weight of a base polymer of the adhesive agent, and from 0.3 to 2 wt. % of aluminum metal pieces relative to the amount of the white pigment added, the adhesive agent being laminated on one surface of a colored film having a total light transmittance of 3 to 80%”.

Patent Document 3 (JP 2007-269928 A) discloses “an adhesive sheet including: a substrate film composed of a single layer; and an adhesive layer, where a specular gloss Gs (60°) of the substrate film is 80% or greater, and a storage elastic modulus of the substrate film at any temperature of 70 to 90° C. is in a range of 1.0×10¹ to 2.8×10² MPa”.

Patent Document 4 (JP 2013-237216 A) discloses “a decorative sheet including a surface layer and an adhesive layer, with the surface layer being a polyurethane layer obtained by: crosslinking using 0.1 to 2.0 equivalents of a curing agent per acid value of carboxyl groups, and coating and drying of a straight chain polyurethane resin obtained by reaction of a diamine chain extender agent with a polyurethane prepolymer obtained by reaction of a polycarbonate diol having an alicyclic structure, an aliphatic diol having a carboxyl group, and an isocyanate including 4,4′-cyclohexylmethanediisocyanate, wherein the molecular weight of the straight chain polyurethane resin is in the range from approximately 50000 to approximately 350000, and the straight chain polyurethane resin exhibits an acid value in the range from approximately 20.0 to approximately 30.0 mg KOH/g”.

### SUMMARY OF INVENTION

### Technical Problem

In car wrapping applications, there is a demand for the decorative film to have multiple functions, such as coloring and paint protection. For example, a colored decorative film is applied to a body of an automobile, and then a transparent protection film is applied over the colored decorative film to achieve coloring and paint protection. However, when the colored decorative film and the transparent protection film are applied and laminated on the automobile body, issues may arise with the durability, heat shrinkage, or weather resistance of the laminate.

Therefore, there is a demand for a decorative film having multiple functions, such as coloring and paint protection in a single product. Further, the decorative film is desirably a non-PVC-based decorative film.

It is conceivable to use a colored polyurethane film as solutions to such demands. A polyurethane film is typically colored by printing an ink containing a pigment and a binder on the surface of the polyurethane film to form a decorative layer (print layer) on the polyurethane film. However, when the polyurethane film is provided with a decorative layer (print layer) containing a material different from that of polyurethane, the elongation property originally possessed by the polyurethane film may deteriorate. When the color of the decorative layer is changed, the degree of deterioration of the elongation property of the polyurethane film may vary depending on the pigment or the binder contained in the decorative layer. This is considered to be because the pigment acts not only as a colorant but also as a filler in the decorative layer, and the functional group or polar group that the pigment can have affects the physical properties of the binder. When the content of the pigment is increased to obtain a high chromatic color, the physical properties of the binder are more likely to be affected by the pigment. As described above, there is a technical difficulty in the method of coloring the polyurethane film, and it is generally difficult to color the polyurethane film without impairing the inherent physical properties of the polyurethane film.

The present disclosure provides a polyurethane-based decorative film having multiple functions, such as coloring and paint protection, in a single product.

### Solution to Problem

The present inventors have found that it is possible to produce a polyurethane-based decorative film having multiple functions, such as coloring and paint protection in a single product, by combining a transparent thermoplastic polyurethane elastomer film with a colored acrylic pressure-sensitive adhesive layer.

According to an embodiment, provided is a decorative film including: a transparent top layer including a transparent thermoplastic polyurethane elastomer film; and a colored acrylic pressure-sensitive adhesive layer, wherein the decorative film has a tensile strength at 2% strain of 20 N/25 mm or less and an elongation of 150% or greater.

### Advantageous Effects of Invention

According to the present disclosure, there is provided a polyurethane-based decorative film having multiple functions, such as coloring and paint protection in a single product.

Note that the above description is not construed as disclosure of all of the embodiments of the present invention and advantages related to the present invention.

### BRIEF DESCRIPTION OF DRAWINGS

FIG. 1 is a schematic cross-sectional view of a decorative film of an embodiment.

FIG. 2 is a graph showing a relationship between elongation (%) and tensile strength (N/25 mm) of decorative films of Examples 1 to 3 and Reference Example 1.

### DESCRIPTION OF EMBODIMENTS

Hereinafter, the present invention will be described in more detail with reference to the drawings for the purpose of illustrating representative embodiments of the present invention, but the present invention is not limited to these embodiments.

In the present disclosure, the term “(meth)acrylic” refers to acrylic or methacrylic, and the term “(meth)acrylate” refers to acrylate or methacrylate.

In the present disclosure, the term “film” encompasses articles referred to as “sheets”.

In the present disclosure, “pressure-sensitive adhesive(ness)” refers to the characteristic of a material or composition that the material or composition adheres to various surfaces by application of little pressure for a short time in the temperature range of usage, such as from 0° C. to 50° C., and does not exhibit a phase change (from liquid to solid). In the present disclosure, “adhesive(ness)” is used interchangeably with “pressure-sensitive adhesive(ness)”.

In the present disclosure, the term “transparent” refers to a total light transmittance of approximately 80% or greater, preferably approximately 85% or greater or approximately 90% or greater, in the visible light region (wavelength range of 380 nm to 780 nm) measured in accordance with JIS K 7375:2008. An upper limit of the total light transmittance is not particularly limited, and can be, for example, approximately less than 100%, approximately 99% or less, or approximately 98% or less.

In the present disclosure “non-PVC-based” means that a decorative film is substantially free of polyvinyl chloride, for example, a polyvinyl chloride film or a polyvinyl chloride layer. In an embodiment, a content of polyvinyl chloride of a decorative film is approximately 1 mass % or less, approximately 0.5 mass % or less, or approximately 0.1 mass % or less.

In the present disclosure, “weight average molecular weight” is a molecular weight by the gel permeation chromatography (GPC) method calibrated with polystyrene standards.

In the present disclosure, “disposed on” refers to not only the case of being directly disposed on, but also the case of being indirectly disposed on, that is, disposed via another material or layer on.

In the present disclosure, “titanium oxide” is used interchangeably with “titanium dioxide (TiO₂)”.

A decorative film of an embodiment includes: a transparent top layer including a transparent thermoplastic polyurethane elastomer film; and a colored acrylic pressure-sensitive adhesive layer, where the decorative film has a tensile strength at 2% strain of 20 N/25 mm or less and an elongation of 150% or greater. In the decorative film of the present disclosure, physical properties such as elongation, tensile strength, and strength at break of the decorative film are mostly governed by the physical properties of the transparent thermoplastic polyurethane elastomer film contained in the transparent top layer, and are hardly affected by the colored acrylic pressure-sensitive adhesive layer. Accordingly, the decorative film of the present disclosure can maximally utilize the inherent physical properties of the transparent thermoplastic polyurethane elastomer film. In addition, since the colored acrylic pressure-sensitive adhesive layer has a function of coloring the decorative film, various product designs using various pigments are possible without impairing the physical properties of the transparent thermoplastic polyurethane elastomer film.

In an embodiment, the decorative film includes a transparent top layer and a colored acrylic pressure-sensitive adhesive layer. The wording “includes a transparent top layer and a colored acrylic pressure-sensitive adhesive layer” means that the decorative film does not include any layers other than the transparent top layer, the colored adhesive layer, and a liner to be removed at the time of use. The decorative film of this embodiment has a simple layer structure and thus can more advantageously accommodate regulations relating to flame retardance in each country.

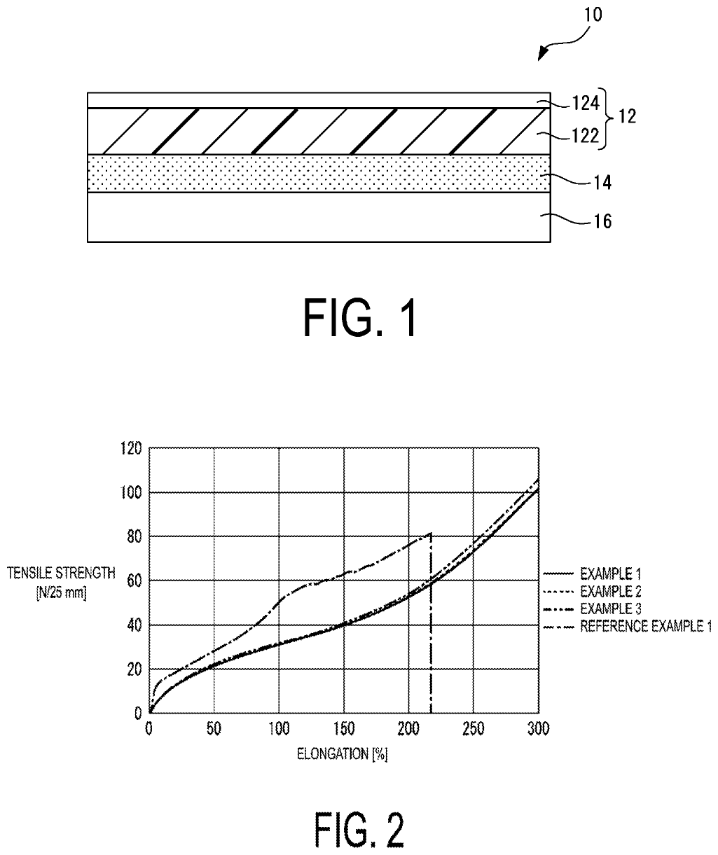

FIG. 1 illustrates a schematic cross-sectional view of a decorative film of an embodiment. A decorative film 10 includes a transparent top layer 12 and a colored acrylic pressure-sensitive adhesive layer 14. The transparent top layer 12 includes a transparent thermoplastic polyurethane elastomer film 122. In FIG. 1, a topcoat layer 124 disposed on the transparent thermoplastic polyurethane elastomer film 122 is illustrated as an optional component of the transparent top layer 12. The decorative film 10 of FIG. 1 further includes a liner 16 as an optional component. The liner 16 is removed before adhesion of the decorative film 10 to an adherend.

The transparent top layer may be a single layer or a multi-layer. In an embodiment, the transparent top layer is a single layer, and in other words, includes a transparent thermoplastic polyurethane elastomer film. This embodiment is advantageous from the perspective of the physical properties of the decorative film, the material cost for the production of the decorative film, and the process of producing the decorative film, because the layer structure is simple and interlayer peeling does not occur in the transparent top layer. In another embodiment, the transparent top layer is a multi-layer and includes another layer such as a topcoat layer disposed on the transparent thermoplastic polyurethane elastomer film.

The transparent thermoplastic polyurethane elastomer film is not particularly limited as long as it is a film including a transparent thermoplastic polyurethane elastomer. The thermoplastic polyurethane elastomer can impart high strength, weather resistance, and durability to the decorative film. The thermoplastic polyurethane elastomer is a block copolymer including a hard segment and a soft segment, the hard and soft segments each having a urethane bond in a molecule thereof, and is synthesized by a polyaddition reaction of polyol and polyisocyanate. The hard segment is a molecular constraint component that prevents plastic deformation of the polyurethane, and the soft segment imparts elastomeric properties to the polyurethane. The hard segment of the thermoplastic polyurethane elastomer is typically composed of diisocyanates and, as necessary, short-chain diols (chain extender). The soft segment of the thermoplastic polyurethane elastomer is typically composed of long-chain polyols. One type of the thermoplastic polyurethane elastomer may be used alone, or two or more types of the thermoplastic polyurethane elastomers may be used in combination.

Examples of the long-chain polyol include polyester polyol, polylactone polyol, polyether polyol, and polycarbonate polyol. Examples of the polyester polyol include poly(ethylene adipate)glycol, poly(1,4-butylene adipate)glycol, and poly(1,6-hexylene adipate)glycol. Examples of the polylactone polyol include poly(ε-caprolactone)diol.

Examples of the polyether polyol include poly(oxyethylene)glycol, poly(oxypropylene)glycol, and poly(oxytetramethylene)glycol. Examples of the polycarbonate polyol include poly(hexanediol-1,6-carbonate)glycol. The long-chain polyol is preferably a diol. The long-chain polyol is preferably an aliphatic polyester polyol due to excellent transparency and non-yellowing properties. One type of the long-chain polyol may be used alone, or two or more types of the long-chain polyols may be used in combination.

Examples of the short-chain polyol include ethylene glycol, 1,2-propylene glycol, 1,3-propylene glycol, 1,2-butanediol, 1,3-butanediol, 1,4-butanediol, 2-methyl-1,3-propanediol, and 1,4-hexanediol. The short-chain polyol is preferably a diol. The short-chain polyol is preferably an aliphatic polyol due to excellent transparency and non-yellowing properties. One type of the short-chain polyol may be used alone, or two or more types of the short-chain polyols may be used in combination.

A chain extender other than the short-chain polyol may be used. Examples of the chain extender include polyamines such as ethylenediamine, hexamethylenediamine, xylylenediamine, isophoronediamine, and ethylenetriamine; and amino alcohols such as monoethanolamine, diethanolamine, and monopropanolamine. One type of the chain extender other than the short-chain polyol may be used alone, or two or more types of the chain extenders may be used in combination.

Examples of the diisocyanate include aromatic diisocyanates such as 4,4′-diphenylmethane diisocyanate (MDI), 2,4-toluene diisocyanate (2,4-TDI), 2,6-toluene diisocyanate (2,6-TDI), m-xylylene diisocyanate, 1,4-phenylene diisocyanate (PPDI), and 1,5-diisocyanatonaphthalene (NDI); aliphatic diisocyanates such as hexamethylene diisocyanate (HDI); and alicyclic diisocyanates such as 4,4′-dicyclohexylmethane diisocyanate, 1-isocyanato-3-isocyanatomethyl-3,5,5-trimethylcyclohexane (IPDI), trans-cyclohexane-1,4-diisocyanate, hydrogenated xylylene diisocyanate, and hydrogenated MDI. The diisocyanate is preferably an aliphatic diisocyanate or alicyclic diisocyanate. One type of the diisocyanate may be used alone, or two or more types of the diisocyanates may be used in combination.

The thermoplastic polyurethane elastomer is preferably an aliphatic or alicyclic thermoplastic polyurethane elastomer because it has good weather resistance and non-yellowing properties.

The elastomeric properties of the thermoplastic polyurethane elastomer can be adjusted by the weight average molecular weight of the thermoplastic polyurethane elastomer.

The 100% elastic modulus (storage elastic modulus at 100% elongation) of the thermoplastic polyurethane elastomer can be, for example, approximately 100 MPa or greater, or approximately 250 MPa or greater, and can be approximately 2000 MPa or less, or approximately 1500 MPa or less at 20° C.

The thermoplastic polyurethane elastomer may include an additive such as a UV absorber, a light stabilizer, or a thermal stabilizer as an optional component.

The thickness of the thermoplastic polyurethane elastomer film is not particularly limited and, for example, can be approximately 5 μm or greater, approximately 10 μm or greater, or approximately 25 μm or greater, and can be approximately 500 μm or less, approximately 300 μm or less, or approximately 200 μm or less.

The transparent top layer may include a topcoat layer on an opposite side of the colored acrylic pressure-sensitive adhesive layer of the transparent thermoplastic polyurethane elastomer film. The formation of the topcoat layer achieves improvement in the weather resistance, solvent resistance, chemical resistance, and scratch resistance of the decorative film. The topcoat layer may include, for example, a urethane acrylic resin, an acrylic resin, a fluorine-based resin, or a combination of these resins.

The thickness of the topcoat layer can be, for example, approximately 1 μm or greater, approximately 1.5 μm or greater, or approximately 2 μm or greater, and can be approximately 20 μm or less, approximately 10 μm or less, or approximately 5 μm or less.

The transparent top layer may be colored or colorless. The transparent top layer may include a substantially smooth surface, or may include a matted surface or a structured surface that can be formed by surface processing such as embossing. Appearance or a shape of the transparent top layer is as described above, which can impart various decorating properties to the decorative film.

In an embodiment, the total light transmittance of the transparent top layer in a wavelength range of 380 to 780 nm is approximately 80% or greater. In this embodiment, the color of the colored acrylic pressure-sensitive adhesive layer can be visually recognized without any change through the transparent top layer.

The thickness of the transparent top layer is not particularly limited and, for example, can be approximately 5 μm or greater, approximately 10 μm or greater, or approximately 25 μm or greater, and can be approximately 500 μm or less, approximately 300 μm or less, or approximately 200 μm or less. By setting the thickness of the transparent top layer to approximately 5 μm or greater, it is possible to impart strength, weather resistance, and chemical resistance to the decorative film. By setting the thickness of the transparent top layer to approximately 500 μm or less, it is possible to impart shape followability to the decorative film. When the transparent top layer has a multilayer structure including a thermoplastic polyurethane elastomer film and another layer, for example, a topcoat layer, the thickness described above means the total thickness of the transparent top layer.

In an embodiment, the thickness of the transparent top layer is approximately 50 μm or greater. Thickening of the transparent top layer makes it possible to obtain various colors including deep black such as piano black and visual effects.

The colored acrylic pressure-sensitive adhesive layer contains a colorant and imparts decorating property and/or concealing property to the decorative film. The colored acrylic pressure-sensitive adhesive layer can be formed by typically using a colored adhesive composition containing an adhesive polymer and a colorant. The adhesive polymer may be a (meth)acrylic polymer. The colored acrylic pressure-sensitive adhesive layer may be crosslinked with a crosslinking agent such as a bisamide crosslinking agent, an aziridine crosslinking agent, a carbodiimide crosslinking agent, an epoxy crosslinking agent, or an isocyanate crosslinking agent.

Examples of the colorant include pigments and dyes. A pigment or dye can each be used alone, or two or more of them can each be used in combination. The form of the pigment and dye is not particularly limited and may have undergone dispersion treatment.

Examples of the pigment include inorganic pigments, such as titanium oxide, zinc carbonate, zinc oxide, zinc sulfide, calcium carbonate, barium sulfate, talc, kaolin, carbon black, chrome yellow, yellow iron oxide, colcothar, red oxide of iron, barium sulfate, alumina, zirconia, iron oxide-based pigments, iron hydroxide-based pigments, chromium oxide-based pigments, spinel-type calcined pigments, chromic acid-based pigments, chrome vermilion-based pigments, iron blue-based pigments, aluminum powder-based pigments, bronze powder-based pigments, and calcium phosphate; and organic pigments, such as phthalocyanine-based pigments such as phthalocyanine blue and phthalocyanine green, azo-based pigments, condensed azo-based pigments, azo lake-based pigments, anthraquinone-based pigments, indigo-based pigments, thioindigo-based pigments, isoindolinone-based pigments, azomethine azo-based pigments, aniline black-based pigments, triphenylmethane-based pigments, perinone-based pigments, perylene-based pigments, quinophthalone-based pigments, dioxazine-based pigments, and quinacridone-based pigments, such as quinacridone red.

Examples of the dye include azo-based dyes, anthraquinone-based dyes, quinophthalone-based dyes, styryl-based dyes, diphenylmethane-based dyes, triphenylmethane-based dyes, oxazine-based dyes, triazine-based dyes, xanthane-based dyes, azomethine-based dyes, acridine-based dyes, and diazine-based dyes.

The content of the colorant may be varied based on the decorating property, concealing property and adhesive properties desired for the decorative film and, for example, can be approximately 0.1 mass % or greater, approximately 0.5 mass % or greater, or approximately 1 mass % or greater, and can be approximately 50 mass % or less, approximately 45 mass % or less, or approximately 40 mass % or less, based on the mass of the colored acrylic pressure-sensitive adhesive layer.

In an embodiment in which the decorative film is required to have the concealing property, it is preferable that the colorant contains a white pigment such as titanium oxide, zinc carbonate, zinc oxide, zinc sulfide, calcium carbonate, or barium sulfate, particularly titanium oxide. In the embodiment, the content of the colorant can be approximately 5 mass % or greater, approximately 10 mass % or greater, or approximately 15 mass % or greater, and can be approximately 50 mass % or less, approximately 45 mass % or less, or approximately 40 mass % or less, based on the mass of the colored acrylic pressure-sensitive adhesive layer. The colored acrylic pressure-sensitive adhesive layer contains from approximately 5 mass % to approximately 50 mass % of a white pigment, and this can partially or completely conceal an adherend (underlying layer) surface to which the decorative film is applied.

In an embodiment, the glass transition temperature (Tg) of the adhesive polymer of the colored acrylic pressure-sensitive adhesive layer is approximately −40° C. or lower. By setting the glass transition temperature of the adhesive polymer to approximately −40° C. or lower, initial adhesion (tackiness) can be effectively imparted to the colored acrylic pressure-sensitive adhesive layer.

In a case where an adhesive polymer is a (meth)acrylic polymer, the glass transition temperature of the adhesive polymer can be determined as a calculated glass transition temperature according to the following Fox equation (Fox, T. G., Bull. Am. Phys. Soc., 1 (1956), p. 123), assuming that each of the polymers is copolymerized with n types of monomers.

$$\frac{1}{Tg + 273.15} = {\sum }_{i = 1}^{n} ( \frac{{X}_{i}}{{Tg}_{i} + 273.15} ) \qquad [ Math . 1 ]$$

In the equation, Tgᵢ represents the glass transition temperature (° C.) of a homopolymer of a component i, Xᵢ represents the mass fraction of the monomer of the component i added during polymerization, and i is a natural number of 1 to n, and

$${\sum }_{i = 1}^{n} {X}_{i} = 1 \qquad [ Math . 2 ]$$

In an embodiment, the colored acrylic pressure-sensitive adhesive layer contains a carboxy group-containing (meth)acrylic polymer and an amino group-containing (meth)acrylic polymer. The carboxy group-containing (meth)acrylic polymer and the amino group-containing (meth)acrylic polymer have capability of stably dispersing a large amount of colorant in the colored acrylic pressure-sensitive adhesive layer. Thus, even when the colored acrylic pressure-sensitive adhesive layer is made relatively thin, decorating property and/or concealing property can be imparted to the colored acrylic pressure-sensitive adhesive layer. Capability of making the colored acrylic pressure-sensitive adhesive layer thin is advantageous from the perspective of nonflammability of the decorative film. Furthermore, the carboxy group-containing (meth)acrylic polymer and the amino group-containing (meth)acrylic polymer interact with each other and can suppress reduction in cohesive force of the colored acrylic pressure-sensitive adhesive layer due to dispersion of the colorant and can maintain the adhesive properties. The carboxy group-containing (meth)acrylic polymer and/or the amino group-containing (meth)acrylic polymer may be crosslinked with the above-described crosslinking agent.

The carboxy group-containing (meth)acrylic polymer can be obtained by copolymerizing a polymerizable composition containing a (meth)acrylic monomer and a carboxy group-containing monomer and, as necessary, a monomer having another monoethylenic unsaturated group. In the present disclosure, a (meth)acrylic monomer, a carboxy group-containing monomer, an amino group-containing monomer, and a monomer having another monoethylenic unsaturated group are collectively referred to as polymerizable components. The (meth)acrylic monomer, the carboxy group-containing monomer, and the monomer having another monoethylenic unsaturated group may be used alone or may be used in combination of two or more types.

The (meth)acrylic monomer typically includes an alkyl (meth)acrylate. The number of carbon atoms of the alkyl group of the alkyl (meth)acrylate may be from 1 to 12. Examples of the alkyl (meth)acrylate include linear or branched alkyl (meth)acrylate, such as methyl (meth)acrylate, ethyl (meth)acrylate, n-butyl (meth)acrylate, isobutyl (meth)acrylate, 2-methylbutyl (meth)acrylate, isoamyl (meth)acrylate, n-hexyl (meth)acrylate, n-octyl (meth)acrylate, isooctyl (meth)acrylate, 2-ethylhexyl (meth)acrylate, n-nonyl (meth)acrylate, isononyl (meth)acrylate, n-decyl (meth)acrylate, isodecyl (meth)acrylate, and n-dodecyl (meth)acrylate; and alicyclic (meth)acrylate, such as cyclohexyl (meth)acrylate, 4-t-butylcyclohexyl (meth)acrylate, and isobornyl (meth)acrylate. The alkyl (meth)acrylate preferably includes methyl (meth)acrylate, n-butyl (meth)acrylate, 2-ethylhexyl acrylate, or a combination of these.

The alkyl (meth)acrylate constitutes the main component of the carboxy group-containing (meth)acrylic polymer. In an embodiment, the carboxy group-containing (meth)acrylic polymer is obtained by copolymerizing a polymerizable composition containing the alkyl (meth)acrylate in an amount of approximately 50 mass % or greater, approximately 70 mass % or greater, or approximately 80 mass % or greater, and approximately 99.5 mass % or less, approximately 99 mass % or less, or approximately 98 mass % or less, relative to the mass of the polymerizable components, and includes structural units derived from the alkyl (meth)acrylate in the mass ratio described above.

The (meth)acrylic monomer may include aromatic (meth)acrylate such as phenyl (meth)acrylate and p-tolyl (meth)acrylate; phenoxy alkyl (meth)acrylate such as phenoxy ethyl (meth)acrylate; alkoxy alkyl (meth)acrylate such as methoxypropyl (meth)acrylate and 2-methoxybutyl (meth)acrylate; or cyclic ether-containing (meth)acrylate such as glycidyl (meth)acrylate or tetrahydrofurfuryl (meth)acrylate.

Examples of the carboxy group-containing monomer include (meth)acrylic acid, phthalic acid monohydroxyethyl (meth)acrylate, β-carboxyethyl (meth)acrylate, 2-(meth)acryloyloxyethyl succinic acid, 2-(meth)acryloyloxyethyl hexahydrophthalic acid, crotonic acid, itaconic acid, fumaric acid, citraconic acid, and maleic acid. As the carboxy group-containing monomer, (meth)acrylic acid is preferred. In the present disclosure, a substance that corresponds to the (meth)acrylic monomer and the carboxy group-containing monomer, such as (meth)acrylic acid, is treated as a carboxy group-containing monomer.

In an embodiment, the carboxy group-containing (meth)acrylic polymer is obtained by copolymerizing a polymerizable composition containing the carboxy group-containing monomer in an amount of approximately 0.5 mass % or greater, approximately 1 mass % or greater, or approximately 2 mass % or greater, and approximately 15 mass % or less, approximately 10 mass % or less, or approximately 8 mass % or less, relative to the mass of the polymerizable components, and includes structural units derived from the carboxy group-containing monomer in the mass ratio described above.

Examples of the (meth)acrylic monomer or the monomer having another monoethylenic unsaturated group include amide group-containing monomers, such as (meth)acrylamide, N-vinylpyrrolidone, and N-vinylcaprolactam; hydroxy group-containing monomers, such as 2-hydroxyethyl (meth)acrylate, 2-hydroxypropyl (meth)acrylate, and 4-hydroxybutyl (meth)acrylate; unsaturated nitriles, such as (meth)acrylonitrile; aromatic vinyl monomers, such as styrene, α-methylstyrene, and vinyl toluene; and vinyl esters, such as vinyl acetate.

The copolymerization of the carboxy group-containing (meth)acrylic polymer can be performed by radical polymerization. As the radical polymerization, a known polymerization method can be utilized, such as solution polymerization, suspension polymerization, emulsion polymerization, and bulk polymerization. It is advantageous to use solution polymerization that can easily synthesize a polymer with a high molecular weight. As the polymerization initiator, for example, an organic peroxide such as benzoyl peroxide, lauroyl peroxide, or bis(4-tert-butylcyclohexyl)peroxydicarbonate; or an azo-based polymerization initiator such as 2,2′-azobisisobutyronitrile, 2,2′-azobis(2-methylbutyronitrile), dimethyl-2,2-azobis(2-methylpropionate), 4,4′-azobis(4-cyanovalerianic acid), dimethyl 2,2′-azobis(2-methylpropionate), or azobis(2,4-dimethylvaleronitrile) (AVN) can be used. The polymerization initiator is used typically in an amount of approximately 0.01 parts by mass or greater, or approximately 0.05 parts by mass or greater, and approximately 5 parts by mass or less, or approximately 3 parts by mass or less, relative to 100 parts by mass of the polymerizable components.

The amino group-containing (meth)acrylic polymer increases cohesive force of the colored acrylic pressure-sensitive adhesive layer through the interaction with the carboxy group-containing (meth)acrylic polymer and can improve adhesive properties of the colored acrylic pressure-sensitive adhesive layer.

The amino group-containing (meth)acrylic polymer can be obtained by copolymerizing a polymerizable composition containing a (meth)acrylic monomer and an amino group-containing monomer and, as necessary, a monomer having another monoethylenic unsaturated group. The (meth)acrylic monomer, the amino group-containing monomer, and the monomer having another monoethylenic unsaturated group may be used alone or may be used in combination of two or more types.

As the (meth)acrylic monomer and the monomer having another monoethylenic unsaturated group, the groups identical to those described for the carboxy group-containing (meth)acrylic polymer can be used.

The alkyl (meth)acrylate constitutes the main component of the amino group-containing (meth)acrylic polymer. In an embodiment, the amino group-containing (meth)acrylic polymer is obtained by copolymerizing a polymerizable composition containing the alkyl (meth)acrylate in an amount of approximately 50 mass % or greater, approximately 70 mass % or greater, or approximately 80 mass % or greater, and approximately 99.5 mass % or less, approximately 99 mass % or less, or approximately 98 mass % or less, relative to the mass of the polymerizable components, and includes structural units derived from the alkyl (meth)acrylate in the mass ratio described above.

Examples of the amino group-containing monomer include aminoalkyl (meth)acrylate such as aminoethyl (meth)acrylate; monoalkylaminoalkyl (meth)acrylate such as butylaminoethyl (meth)acrylate; dialkylaminoalkyl (meth)acrylates such as N,N-dimethylaminoethyl acrylate (DMAEA) and N,N-dimethylaminoethyl methacrylate (DMAEMA); dialkylaminoalkyl (meth)acrylamides such as N,N-dimethylaminopropyl acrylamide (DMAPAA) and N,N-dimethylaminopropyl methacrylamide; and dialkylaminoalkyl vinyl ethers such as N,N-dimethylaminoethyl vinyl ether and N,N-diethylaminoethyl vinyl ether. As the amino group-containing monomer, dialkylamino alkyl(meth)acrylate such as N,N-dimethylaminoethyl acrylate (DMAEA) or N,N-dimethylaminoethyl methacrylate (DMAEMA) is preferred. In the present disclosure, a substance that corresponds to the (meth)acrylic monomer and the amino group-containing monomer, such as aminoethyl (meth)acrylate, is treated as an amino group-containing monomer.

In an embodiment, the amino group-containing (meth)acrylic polymer is obtained by copolymerizing a polymerizable composition containing the amino group-containing monomer in an amount of approximately 0.5 mass % or greater, approximately 1 mass % or greater, or approximately 2 mass % or greater, and approximately 20 mass % or less, approximately 15 mass % or less, or approximately 10 mass % or less, relative to the mass of the polymerizable components, and includes structural units derived from the amino group-containing monomer in the mass ratio described above.

The amino group-containing (meth)acrylic polymer is preferably an amino group-containing (meth)acrylic polymer containing no monomer unit derived from aromatic vinyl monomers (hereinafter, in the present disclosure, also referred to as “amino group-containing non-aromatic (meth)acrylic polymer”). The amino group-containing non-aromatic (meth)acrylic polymer has excellent miscibility with the carboxy group-containing (meth)acrylic polymer and thus enables the interaction with the carboxy group-containing (meth)acrylic polymer to be more effective.

The amino group-containing non-aromatic (meth)acrylic polymer contains no structural units derived from aromatic vinyl monomers. Examples of the aromatic vinyl monomer include styrene, α-methylstyrene, vinyltoluene, vinylnaphthalene, vinylanthracene, vinylanthraquinone, (meth)acrylamide of aromatic amine, and (meth)acrylate of hydroxy group-containing aromatic compounds. Examples of the aromatic amine include aniline, benzylamine, naphthylamine, aminoanthracene, aminoanthraquinone, and derivatives of these. Examples of the hydroxy group-containing aromatic compound include hydroxy group-containing compounds corresponding to the aromatic amines described above.

The copolymerization of the amino group-containing (meth)acrylic polymer can be performed by radical polymerization in the same manner as for the copolymerization of the carboxy group-containing (meth)acrylic polymer. The polymerization method, the polymerization initiator and the used amount thereof are the same as those described for the copolymerization of the carboxy group-containing (meth)acrylic polymer.

In the colored acrylic pressure-sensitive adhesive layer, at least one of the carboxy group-containing (meth)acrylic polymer or the amino group-containing (meth)acrylic polymer functions as an acrylic adhesive polymer. The acrylic adhesive polymer imparts pressure sensitive adhesiveness to the colored acrylic pressure-sensitive adhesive layer at the operating temperature (e.g., 5° C. to 35° C.).

The glass transition temperature (Tg) of the acrylic adhesive polymer may be approximately −70° C. to approximately −40° C. In an embodiment, the glass transition temperature of the acrylic adhesive polymer is approximately −65° C. or higher, or approximately −60° C. or higher, and approximately −45° C. or lower, or approximately −50° C. or lower. By setting the glass transition temperature of the acrylic adhesive polymer to approximately −70° C. or higher, adhesive strength and retention strength can be imparted to the colored acrylic pressure-sensitive adhesive layer. By setting the glass transition temperature of the acrylic adhesive polymer to approximately −40° C. or lower, initial adhesion (tackiness) can be effectively imparted to the colored acrylic pressure-sensitive adhesive layer. The glass transition temperature (Tg) of the acrylic adhesive polymer can be determined as a calculated glass transition temperature by using the Fox equation described above.

In an embodiment, the weight average molecular weight (Mw) of the acrylic adhesive polymer is approximately 150000 or greater, approximately 200000 or greater, or approximately 250000 or greater, and approximately 2000000 or less, approximately 1500000 or less, or approximately 1000000 or less.

The mass ratio of the carboxy group-containing (meth)acrylic polymer to the amino group-containing (meth)acrylic polymer is 100:approximately from 0.1 to 50, 100:approximately from 1 to 40, or 100:approximately from 2 to 30 (in a case where the carboxy group-containing (meth)acrylic polymer functions as the acrylic adhesive polymer), or approximately from 0.1 to 50:100, approximately from 1 to 40:100, or approximately from 2 to 30:100 (in a case where the amino group-containing (meth)acrylic polymer functions as the acrylic adhesive polymer).

In an embodiment, another (meth)acrylic polymer that is different from the (meth)acrylic polymer functioning as an acrylic adhesive polymer may function as an acrylic polymer additive. That is, in a case where the carboxy group-containing (meth)acrylic polymer functions as the acrylic adhesive polymer, the amino group-containing (meth)acrylic polymer may function as the acrylic polymer additive, and in a case where the amino group-containing (meth)acrylic polymer functions as the acrylic adhesive polymer, the carboxy group-containing (meth)acrylic polymer may function as the acrylic polymer additive. Through acid (carboxy group)-base (amino group) interaction with the acrylic adhesive polymer, the acrylic polymer additive can suppress reduction of the cohesive force due to depolymerization of the acrylic adhesive polymer caused by exposure to sunlight or the like, and can maintain the adhesive strength of the colored acrylic pressure-sensitive adhesive layer to a desired level.

In an embodiment, the carboxy group-containing (meth)acrylic polymer is the acrylic adhesive polymer, and the amino group-containing (meth)acrylic polymer is the acrylic polymer additive.

The glass transition temperature (Tg) of the acrylic polymer additive can be approximately 20° C. to approximately 120° C. In an embodiment, the glass transition temperature of the acrylic polymer additive is approximately 30° C. or higher, or approximately 45° C. or higher, and approximately 100° C. or lower, or approximately 80° C. or lower. By setting the glass transition temperature of the acrylic polymer additive to approximately 20° C. or higher, it is possible to suppress reduction of the cohesive force due to depolymerization of the acrylic adhesive polymer caused by exposure to sunlight or the like, and to maintain the adhesive strength of the colored acrylic pressure-sensitive adhesive layer to a desired level. By setting the glass transition temperature of the acrylic polymer additive to approximately 120° C. or lower, adhesiveness in an ordinary temperature range can be secured. The glass transition temperature of the acrylic polymer additive can be determined by using the Fox equation similarly to the acrylic adhesive polymer.

In an embodiment, the weight average molecular weight (Mw) of the acrylic polymer additive is approximately 1000 or greater, approximately 5000 or greater, or approximately 10000 or greater, and approximately 200000 or less, approximately 100000 or less, or approximately 80000 or less.

At least one of the carboxy group-containing (meth)acrylic polymer or the amino group-containing (meth)acrylic polymer may function as a dispersant for the colorant. In this embodiment, a premix (also referred to as millbase) may be prepared by mixing the colorant and a (meth)acrylic polymer functioning as a dispersant, and the obtained premix may be mixed with other components of the colored adhesive composition used to form the colored acrylic pressure-sensitive adhesive layer. Thus, a large amount of the colorant can be stably dispersed in the colored acrylic pressure-sensitive adhesive layer. A premix is prepared for each of a plurality of colorants, these premixes are appropriately mixed, thereby color matching can also be facilitated.

The carboxy group-containing (meth)acrylic polymer or the amino group-containing (meth)acrylic polymer that functions as a dispersant may be the same or different from the substance that functions as the acrylic adhesive polymer or the acrylic polymer additive. In the latter case, the colored acrylic pressure-sensitive adhesive layer contains two or more types of carboxy group-containing (meth)acrylic polymers or amino group-containing (meth)acrylic polymers, that is, contains a carboxy group-containing (meth)acrylic polymer or amino group-containing (meth)acrylic polymer that functions as a dispersant, and a carboxy group-containing (meth)acrylic polymer or amino group-containing (meth)acrylic polymer that functions as an acrylic adhesive polymer or acrylic polymer additive.

The weight average molecular weight (Mw) of the carboxy group-containing (meth)acrylic polymer or amino group-containing (meth)acrylic polymer that functions as the dispersant can be typically approximately 1000 or greater or approximately 10000 or greater, and approximately 1500000 or less or approximately 800000 or less.

The colored acrylic pressure-sensitive adhesive layer can be formed on the transparent thermoplastic polyurethane elastomer film of the transparent top layer or the liner by using a colored adhesive composition containing the carboxy group-containing (meth)acrylic polymer, the amino group-containing (meth)acrylic polymer, and the colorant, and, as necessary, a crosslinking agent, a solvent, and/or other additives.

Before preparation of the colored adhesive composition, a premix may be prepared by mixing the colorant, the carboxy group-containing (meth)acrylic polymer or amino group-containing (meth)acrylic polymer that functions as a dispersing agent. The mixing can be performed by using, for example, a paint shaker, a sand grind mill, a ball mill, an attritor mill, or a three roll mill. At the time of mixing, as necessary, a water-based solvent or an organic solvent may be added. The resulting premix is mixed with an additional component of the colored adhesive composition, and the colored adhesive composition can be prepared. In a case where a plurality of colorants is used, each premix may be prepared for each colorant, then color may be adjusted by appropriately mixing these premixes, and the premix mixture may be mixed with other components of the colored adhesive composition.

The mass ratio of the total amount of colorant to the amount of the dispersant can be approximately 1 to 100: approximately from 5 to 1000, approximately from 1 to 100: approximately from 10 to 700, or approximately from 1 to 100:approximately from 10 to 500. The entire amount of the dispersant may be used during preparation of the premix, or part of the dispersant may be used during preparation of the premix and the rest of the dispersant may be used during preparation of the colored adhesive composition.

The crosslinking agent is not particularly limited as long as the crosslinking agent can form a crosslink between polymer chains of the carboxy group-containing (meth)acrylic polymer or amino group-containing (meth)acrylic polymer. For example, as the crosslinking agent of the carboxy group-containing (meth)acrylic polymer, an epoxy crosslinking agent, a bisamide crosslinking agent, an aziridine crosslinking agent, a carbodiimide crosslinking agent, or an isocyanate crosslinking agent can be used.

Examples of the epoxy crosslinking agent include N,N,N′,N′-tetraglycidyl-1,3-benzenedi(methanamine) (trade name: TETRAD-X (Mitsubishi Gas Chemical Company Inc., Chiyoda-ku, Tokyo, Japan), E-AX and E-5XM (both from Soken Chemical & Engineering Co., Ltd., Toshima-ku, Tokyo, Japan)); and N,N′-(cyclohexane-1,3-diylbismethylene)bis(diglycidylamine) (trade name: TETRAD-C (Mitsubishi Gas Chemical Company Inc., Chiyoda-ku, Tokyo, Japan), and E-5C (Soken Chemical & Engineering Co., Ltd., Toshima-ku, Tokyo, Japan)).

Examples of the bisamide crosslinking agent include 1,1′-isophthaloyl-bis(2-methylaziridine), 1,4-bis(ethyleneiminocarbonylamino)benzene, 4,4′-bis(ethyleneiminocarbonylamino)diphenylmethane, and 1,8-bis(ethyleneiminocarbonylamino)octane.

Examples of the aziridine crosslinking agent include 2,2-bishydroxymethylbutanol-tris[3-(1-aziridinyl)propionate (trade name: CHEMITITE (trade name) PZ-33 (Nippon Shokubai Co., Ltd. (Osaka-shi, Osaka, Japan)), and Crosslinker CX-100 (DSM Coating Resins B. V. (Zwolle, Netherlands)).

Examples of the carbodiimide crosslinking agent include Carbodilite V-03, V-05, and V-07 (all from Nisshinbo Chemical Inc. (Chuo-ku, Tokyo, Japan)).

Examples of the isocyanate crosslinking agent include Coronate L and Coronate HK (both from Tosoh Corporation (Minato-ku, Tokyo, Japan)).

The crosslinking agent can be used in an amount of approximately 0.01 parts by mass or greater, approximately 0.02 parts by mass or greater, or approximately 0.05 parts by mass or greater, and approximately 0.5 parts by mass or less, approximately 0.4 parts by mass or less, or approximately 0.3 parts by mass or less, per 100 parts by mass of the carboxy group-containing (meth)acrylic polymer or amino group-containing (meth)acrylic polymer that functions as the acrylic adhesive polymer.

Examples of the solvent include methanol, ethanol, hexane, heptane, toluene, acetone, methyl ethyl ketone, methyl isobutyl ketone, ethyl acetate, butyl acetate, and mixed solvents thereof.

Examples of other additives include UV absorbents, antioxidants, thermal stabilizers, fillers, and tackifiers.

In an embodiment, the colored acrylic pressure-sensitive adhesive layer contains substantially no flame retardant. Here, “contains substantially no” means that the content of the flame retardant is less than approximately 1 mass %, less than approximately 0.5 mass %, or less than approximately 0.2 mass % based on the mass of the colored acrylic pressure-sensitive adhesive layer. Examples of the flame retardant include organic flame retardants such as bromine-based flame retardants, phosphorus-based flame retardants, and chlorine-based flame retardants, and inorganic flame retardants such as antimony compounds, metal hydroxides, nitrogen compounds, and boron compounds. The colored acrylic pressure-sensitive adhesive layer containing substantially no flame retardant causes no decrease in adhesive strength or no yellowing due to the migration of a flame retardant and thus can retain the adhesive strength and appearance of the decorative film over a long period of time. In the present disclosure, a pigment such as titanium oxide is not included in the content of the flame retardant.

The thickness of the colored acrylic pressure-sensitive adhesive layer may be varied based on the decorating property, concealing property and adhesive properties desired for the decorative film and, for example, can be approximately 5 μm or greater, approximately 10 μm or greater, or approximately 15 μm or greater, and can be approximately 100 μm or less, approximately 80 μm or less, or approximately 50 μm or less. From the perspective of nonflammability of the decorative film, the thickness of the colored acrylic pressure-sensitive adhesive layer is preferably approximately 80 μm or less, and more preferably approximately 50 μm or less.

The decorative film can be produced by a known method. For example, the colored adhesive composition is applied onto a liner with a knife coater, a bar coater, or the like and dried to form a colored acrylic pressure-sensitive adhesive layer. To cause the reaction of the crosslinking agent, which is an optional component, to proceed, the colored acrylic pressure-sensitive adhesive layer may be heated by hot air or an oven during the drying. The transparent top layer is layered on the resulting colored acrylic pressure-sensitive adhesive layer by a method such as dry lamination, such that the thermoplastic polyurethane elastomer film of the transparent top layer is in contact with the colored acrylic pressure-sensitive adhesive layer, and thus a decorative film is formed. A decorative film can be also produced by directly applying a colored adhesive composition on the thermoplastic polyurethane elastomer film of the transparent top layer and drying.

The decorative film may include a liner on the surface of the colored acrylic pressure-sensitive adhesive layer, the surface being on an opposite side of the transparent top layer. Examples of the liner, which is an optional component, include plastic materials such as polyethylenes, polypropylenes, polyesters, and cellulose acetates, papers, and laminated papers of the plastic materials. These liners may have a surface that has been subjected to release-liner treatment with silicone or the like. The thickness of the liner can be typically approximately 10 μm or greater, or approximately 25 μm or greater, and approximately 500 μm or less, or approximately 200 μm or less.

The colored acrylic pressure-sensitive adhesive layer may be solid or may be a porous or foam body. The adhesive surface of the colored acrylic pressure-sensitive adhesive layer may be flat or may have recesses and protrusions. The adhesive surface with recesses and protrusions include an adhesive surface of the colored acrylic pressure-sensitive adhesive layer, in which the protrusions containing a solid content of the colored adhesive composition or a solid content of the reaction product and the recesses surrounding the protrusions are formed, and when the adhesive surface is attached to an adherend, a communicating passage is formed between the adherend surface and the adhesive surface, the communicating passage being defined by the recesses and being in communication with the external space. An example of the method for forming the adhesive surface with recesses and protrusions will be described below.

A liner with a release surface including a prescribed recess-and-protrusion structure is prepared. The colored adhesive composition is applied to the release surface of the liner and, as necessary, heated, and thus a colored acrylic pressure-sensitive adhesive layer is formed. Thus, the recess-and-protrusion structure (negative structure) of the liner is transferred to the surface of the colored acrylic pressure-sensitive adhesive layer, the surface being in contact with the liner (to serve as the adhesive surface in the decorative film), and thus an adhesive surface with recesses and protrusions including the predetermined structure (positive structure) at the adhesive surface is formed. As described above, the recesses and protrusions of the adhesive surface are designed in advance to include a groove that allows formation of the communicating passage when the protrusions adhere to the adherend.

For the groove of the colored acrylic pressure-sensitive adhesive layer, the groove having a consistent shape may be arranged at the adhesive surface in accordance with a regular pattern to form a regularly-patterned groove, or the groove having an indeterminate shape may be arranged to form an irregularly-patterned groove. In a case where multiple grooves are formed to be disposed substantially parallel to each other, the interval at which the grooves are disposed is preferably approximately 10 μm or greater, or approximately 100 μm or greater, and approximately 2000 μm or less, or approximately 1000 μm or less. The depth of the grooves (distance from the adhesive surface to the bottom of the groove measured toward the direction of the transparent top layer) is typically approximately 10 μm or greater and approximately 100 μm or less. The shape of the groove is also not particularly limited, as long as the effect of the present invention is not impaired. For example, the shape of the groove may be substantially rectangular (including trapezoidal), substantially semi-circular, or substantially semi-elliptical at a cross-section of the groove in a direction perpendicular to the adhesive surface.

In an embodiment, the transparent top layer and the colored acrylic pressure-sensitive adhesive layer are disposed adjacent to each other. In other words, in this embodiment, no other layer (e.g., a printed layer) is interposed between the transparent top layer and the colored acrylic pressure-sensitive adhesive layer. When the transparent top layer and the colored acrylic pressure-sensitive adhesive layer are disposed adjacent to each other, the hue, brightness, and saturation of the colored acrylic pressure-sensitive adhesive layer visually recognized in the state of the decorative film are affected by only the transparent top layer, and are not affected by other elements. Therefore, in this embodiment, the color tone of the colored acrylic pressure-sensitive adhesive layer can be easily adjusted.

The thickness of the decorative film can be approximately 30 μm or greater, approximately 50 μm or greater, or approximately 70 μm or greater, but approximately 1 mm or less, approximately 500 μm or less, or approximately 300 μm or less. The thickness of the decorative film does not include the thickness of the liner. When chipping resistance is required in the decorative film, the thickness of the decorative film is preferably approximately 100 μm or greater, and more preferably approximately 120 μm or greater.

In an embodiment, the thickness of the decorative film is approximately 240 μm or less. The decorative film having a thickness of approximately 240 μm or less can impart required flame retardance to the decorative film. The thickness of the decorative film required to have flame retardance is preferably approximately 200 μm or less, and more preferably approximately 180 μm or less.

In an embodiment, the tensile strength at 2% strain of the decorative film is approximately 20 N/25 mm or less, approximately 15 N/25 mm or less, or approximately 10 N/25 mm or less. The tensile strength at 2% strain of the decorative film is not particularly limited, and can be approximately 0.5 N/25 mm or greater, approximately 1 N/25 mm or greater, or approximately 1.5 N/25 mm or greater. The tensile strength at 2% strain of the decorative film is determined by a method described in the examples.

In an embodiment, the decorative film has an elongation of approximately 150% or greater, approximately 200% or greater, or approximately 300% or greater. A decorative film having an elongation of approximately 150% or greater has high elasticity and excellent flexibility, and thus is excellent in chipping resistance. The elongation of the decorative film is not particularly limited, and can be approximately 1000% or less, approximately 800% or less, or approximately 600% or less. The elongation of the decorative film according to this embodiment is determined by a method described in the examples.

In an embodiment, the decorative film has an elongation of 60% or greater and a strength at break of 50 N/25 mm or greater, as measured in accordance with JIS A 5759:2016 6.8. The decorative film having the elongation and strength at break can be suitably used for preventing glass scattering.

Decorative films preferably effectively conceal, for example, a color or pattern of a surface of an adherend (underlying layer). In the decorative film of an embodiment, when a color difference ΔE* is measured from a side of the transparent top layer with the background color being white and black, the color difference ΔE* is 11 or less between a part of the white background color and a part of the black background color. A decorative film having a color difference ΔE* of 11 or less has an excellent underlying layer concealing property, and can be suitably used for car wrapping. The color difference ΔE* is determined according to the procedure described in the section of “Concealing Power” of the examples by using a spectrophotometer.

The decorative film of an embodiment has a total heat release of 8 MJ/m² or less for 20 minutes after start of heating as measured in accordance with ISO 5660-1 Heat Release Rate (cone calorimeter method). The total heat release is preferably approximately 7 MJ/m² or less, or more preferably 6 MJ/m² or less. The decorative film having a total heat release of 8 MJ/m² or less is evaluated as being nonflammable.

In an embodiment, the decorative film is essentially free of flame retardants. Note that “essentially free” means that the flame retardant is contained in approximately less than 1 mass %, approximately less than 0.5 mass %, or approximately less than 0.2 mass % relative to the mass of the decorative film. Examples of the flame retardant include organic flame retardants such as bromine-based flame retardants, phosphorus-based flame retardants, and chlorine-based flame retardants, and inorganic flame retardants such as antimony compounds, metal hydroxides, nitrogen compounds, and boron compounds. In the present disclosure, pigments that can function as a flame retardant, such as titanium oxide, is not included in the content of the flame retardant.

In an embodiment, the decorative film is a non-PVC-based decorative film.

The decorative film of the present disclosure can be used for exterior purposes, such as vehicles, such as railways and ships; and exterior walls, such as those of buildings, storage tanks, and transformer facilities. Particularly, the decorative film of the present disclosure is excellent in elongation, and thus it can be suitably used as a colored film for car wrapping and a film for scattering prevention. The decorative film of the present disclosure can also be suitably used for decoration of an internally illuminated sign.

### EXAMPLES

In the following examples, specific embodiments of the present disclosure will be exemplified, but the present invention is not limited to those embodiments. All ‘part’ and ‘percent’ are based on mass unless otherwise specified.

The raw materials used in the production of the decorative film are shown in Table 1.

TABLE 1

| | Composition or description¹⁾ | Supplier |
|---|---|---|
| Thermoplastic polyurethane film | Thermoplastic polyester polyurethane elastomer film, | Sheedom Co., Ltd. |
| 1 (TPU1) | thickness 150 μm, non-yellowing | (Osaka-shi, Osaka, Japan) |
| (Meth)acrylic polymer 1 (AP1) | MMA-BMA-DMAEMA = 60:34:6, Tg = 63° C., weight | — |
| | average molecular weight (Mw): 68000, 40 mass % EtOAc | |
| | solution | |
| (Meth)acrylic polymer 2 (AP2) | BA-2EHA-Vac-AA-ACM = 40:47:8:5:0.1, Tg = −51° C., | — |
| | weight average molecular weight (Mw) 550000, 40 mass % | |
| | toluene/EtOAc solution | |
| Adhesive polymer 1 (ADH1) | BA-2EHA-AN-AA = 58:36:2:4, Tg = −53° C., weight | — |
| | average molecular weight (Mw) 500000, 33 mass % EtOAc | |
| | solution | |
| Crosslinking agent 1 (CL1) | Bisamide crosslinking agent, 1,1′-isophthaloyl-bis(2- | 3M Japan Ltd. |
| | methylaziridine), 5 mass % toluene solution | (Shinagawa-ku, Tokyo, Japan) |

¹⁾MMA: methyl methacrylate, BMA: n-butyl methacrylate, DMAEMA: 2-(dimethylamino)ethyl methacrylate
BA: n-butyl acrylate, 2EHA: 2-ethylhexyl acrylate, Vac: vinyl acetate
AA: acrylic acid, ACM: acrylamide, AN: acrylonitrile, EtOAc: ethyl acetate

The pigments 1 to 4 used in the production of the decorative films are shown in Table 2.

TABLE 2

| | Color | C.I. | Description | Supplier |
|---|---|---|---|---|
| Pigment 1 | White | Pigment | Ti-Pure (trade name) | The Chemours Company |
| (PG1) | | White 6 | R960, titanium | (Wilmington, Delaware, |
| | | | dioxide (TiO₂) | USA) |
| Pigment 2 | Orange | Pigment | CROMOPHTAL | BASF |
| (PG2) | | Orange 61 | (trade name) | (Basel, Switzerland) |
| | | | ORANGE 2G | |
| Pigment 3 | Yellow | Pigment | IRGAZIN (trade | BASF |
| (PG3) | | Yellow 154 | name) YELLOW | (Basel, Switzerland) |
| | | | 2GLTE | |
| Pigment 4 | Black | Pigment | Raven (trade name) | Columbian Chemicals |
| (PG4) | | Black 7 | Carbon Black 1200 | Company |
| | | | | (Marietta, Georgia, USA) |

The compositions of Millbases 1 to 4 (premixes) used in production of decorative films are shown in Table 3.

TABLE 3

Resin

| | |
|---|---|
| Pigment | mass % |

| | Type | mass % | Type | (solid content) |
|---|---|---|---|---|
| Millbase 1 (MB1) | PG1 | 55 | AP1 | 11 |
| Millbase 2 (MB2) | PG2 | 10 | AP2 | 16 |
| Millbase 3 (MB3) | PG3 | 10 | AP2 | 16 |
| Millbase 4 (MB4) | PG4 | 5 | AP2 | 20 |

The compositions of colored adhesive compositions CA1 to CA3 used in production of decorative films are shown in Table 4. The colored adhesive compositions CA1 to CA3 were prepared by mixing millbases 1 to 4 and other raw materials.

TABLE 4
(numerical values are in wet mass %)

| | CA1 | CA2 | CA3 |
|---|---|---|---|
| MB1 | 15 | 6 | 5 |
| MB2 | 6 | 11 | 11 |
| MB3 | 8 | 11 | 4 |
| MB4 | 1 | 1 | 3 |
| ADH2 | 71 | 69 | 75 |
| AP1 | — | 2 | 2 |

### Examples 1 to 3

The crosslinking agent 1 (CL1) was mixed into each of the colored adhesive compositions shown in Table 5. The mass ratio of ADH1 and CL1 was 100:0.5 in terms of solid content. Each of the colored adhesive compositions was applied on a liner having a structured surface (SCW860DNL, 3M Japan Limited, Shinagawa-ku, Tokyo, Japan) by using a knife coater and dried at 95° C. for 3 minutes. After drying, pressure-sensitive adhesive layers having a thickness of 25 μm were obtained. Each of the pressure-sensitive adhesive layers was bonded to a thermoplastic polyurethane film 1 (TPU1), and the polyester support film was peeled from the surface of the TPU1, thereby obtaining decorative films of Examples 1 to 3.

### Reference Example 1

3M (trade name) Scotchgard (trade name) Paint Protection Film Pro Series SGH6PRO4 (3M Japan Limited (Shinagawa-ku, Tokyo, Japan)) was used.

### Comparative Example 1

A PVC-based 3M (trade name) Scotchcal (registered trademark) Film JS1236XL (3M Japan Limited, Shinagawa-ku, Tokyo, Japan) was used.

### Comparative Example 2

A PVC-based 3M (trade name) Scotchcal (trade name) Film JS6217XL (3M Japan Limited, Shinagawa-ku, Tokyo, Japan) was used.

The decorative film was evaluated for the following.

### Strength at Break

A test piece was prepared by cutting a decorative film into a width of 25 mm and a length of 150 mm. Using a tensile tester (Tensilon universal testing machine, model: RTC-1210A, manufactured by A&D Company, Limited (Toshima-ku, Tokyo, Japan)), the tensile strength at the breaking point at 20° C. was measured under the condition at 20° C., the distance between grips of 100 mm, at the tensile speed of 300 mm/min.

### Elongation

A test piece was prepared by cutting a decorative film into a width of 25 mm and a length of 150 mm. Using a tensile tester (Tensilon universal testing machine, model: RTC-1210A, manufactured by A&D Company, Limited (Toshima-ku, Tokyo, Japan)), the elongation at 20° C. was measured under the condition at 20° C., the distance between grips of 100 mm, at the tensile speed of 300 mm/min. The elongation is defined by the following equation.

Elongation (%)=(length of test piece after test−length of test piece before test)/length of test piece before test

### Tensile Strength at 2% Strain

A test piece was prepared by cutting a decorative film into a width of 25 mm and a length of 150 mm. Using a tensile tester (Tensilon universal testing machine, model: RTC-1210A, manufactured by A&D Company, Limited (Toshima-ku, Tokyo, Japan)), the tensile strength at 2% strain at 20° C. was measured under the condition at 20° C., the distance between grips of 100 mm, at the tensile speed of 300 mm/min.

### Adhesive Force

A test piece was prepared by cutting a decorative film into a width of 25 mm and a length of 150 mm. The test piece was adhered onto an aluminum panel (PALTEK CORPORATION (Hiratsuka-shi, Kanagawa, Japan)) at 20° C. using a roller. The adhering method was in accordance with JIS Z 0237:2009 8.2.3. The test piece was left at 20° C. for 48 hours. Using a tensile tester (Tensilon universal testing machine, model: RTC-1210A, manufactured by A&D Company, Limited (Toshima-ku, Tokyo, Japan)), the adhesive force at the time of performing 180 degree peeling was measured at a peeling rate of 300 mm/min at 20° C.

### Heat Shrinkage

A test piece was prepared by cutting a decorative film into a width of 50 mm and a length of 100 mm. The test piece was adhered on an aluminum sheet A5052P (Paltek Corporation (Hiratsuka-shi, Kanagawa, Japan)) in an environment at 23° C. by a roller and left for 24 hours in an environment at 23° C. On the test piece, cut in shape of cross was made by a utility knife. The test piece was then heated at 65° C. for 48 hours. After the heat aging, the shrinkage (mm) of the film was measured by a microscope, and a maximum value was recorded.

### Concealing Power

A test piece was produced by cutting a decorative film into a square with 50 mm side. The test piece was adhered on a concealing power chart (checks, concealing power chart, SEIEIDO Printing Co., Ltd. (Yonezawa-shi, Yamagata, Japan)). For the white region and black region, the L*, a*, and b* values of the test piece were measured by using a spectrophotometer (CM-3700d, Konica Minolta Japan, Inc. (Minato-ku, Tokyo, Japan)). When the measured values of the white region are denoted by L₁*, a₁*, and b₁*, and the measured values of the black region are denoted by L₂*, a₂*, and b₂*, the color difference ΔE* as an index of concealing power is calculated and determined by the following equation:

ΔE*=[(L₂*−L₁*)²+(a₂*−a₁*)²+(b₂*−b₁*)²]^{1/2}

### Transmittance

A test piece was produced by cutting a TPU1 into a square with 50 mm side. The total light transmittance, haze, diffuse transmittance, and parallel transmittance of the test piece were measured using a haze meter (HM-150, MURAKAMI COLOR RESEARCH LABORATORY (Chuo-ku, Tokyo, Japan)). The measurement was in accordance with JIS K 7136:2000. An average of three measurements was recorded as a representative measurement value. The TPU1 had a total light transmittance of 91.3% and a haze of 83.4.

The constitutions and evaluation results of decorative films of Examples 1 to 3, Reference Example 1, and Comparative Examples 1 and 2 are shown in Table 5. In FIG. 2, a relationship between elongation (%) and tensile strength (N/25 mm) of decorative films of Examples 1 to 3 and Reference Example 1 is shown in a graph.

TABLE 5

| | | | Acrylic pressure-sensitive adhesive | | | | | |
|---|---|---|---|---|---|---|---|---|
| | | | layer | | | | | |
| | | | | Crosslinking | | | | |
| | Transparent top | | | agent | | | | |
| | layer | | | | Part | | | Total |
| | | Thickness | | | by | Thickness | | thickness |
| | Type | [μm] | Composition | Type | mass | [μm] | Color | [μm] |
| Example 1 | FL1 | 150 | CA1 | CL1 | 0.05 | 25 | Yes | 175 |
| Example 2 | FL1 | 150 | CA2 | CL1 | 0.05 | 25 | Yes | 175 |
| Example 3 | FL1 | 150 | CA3 | CL1 | 0.05 | 25 | Yes | 175 |
| Reference | — | — | — | — | — | — | No | 200 |
| Example 1 | | | | | | | | |
| Comparative | — | — | — | — | — | — | Yes | 83 |
| Example 1 | | | | | | | | |
| Comparative | — | — | — | — | — | — | Yes | 113 |
| Example 2 | | | | | | | | |

| | | | Tensile | | | |
|---|---|---|---|---|---|---|
| | Strength at | | strength at | Adhesive | Heat | |
| | break | Elongation | 2% strain | force | shrinkage | Con [symbol] ling |
| | [N/25 mm] | [%] | (N/25 mm) | (N/25 mm) | [mm] | p [symbol] r |
| Example 1 | >102 | >300 | 2 | 8 | 0.06 | 0.39 |
| Example 2 | >102 | >300 | 2 | 9 | 0.08 | 0.31 |
| Example 3 | >107 | >300 | 3 | 8 | 0.11 | 0.11 |
| Reference | 82 | 220 | 8 | 35 | 0.22 | — |
| Example 1 | | | | | | |
| Comparative | 39 | 189 | 24 | 32 | 0.68 | — |
| Example 1 | | | | | | |
| Comparative | 60 | 205 | 32 | 30 | 0.20 | — |
| Example 2 | | | | | | |

[symbol]

indicates data missing or illegible when filed

Various variations of the above-mentioned embodiments and examples will be apparent to those skilled in the art without departing from the basic principle of the present invention. It is also obvious to a person skilled in the art that various improvement and modifications to the present invention can be implemented without departing from the spirit and scope of the present invention. Some of the embodiments of the present disclosure are described below.

### First Aspect

A decorative film including: a transparent top layer including a transparent thermoplastic polyurethane elastomer film; and a colored acrylic pressure-sensitive adhesive layer, wherein the decorative film has a tensile strength at 2% strain of 20 N/25 mm or less and an elongation of 150% or greater.

### Second Aspect

The decorative film according to the first aspect, wherein the transparent top layer has a total light transmittance in a wavelength range of 380 nm to 780 nm of 80% or greater.

### Third Aspect

The decorative film according to the first or second aspect, wherein the transparent top layer and the colored acrylic pressure-sensitive adhesive layer are disposed adjacent to each other.

### Fourth Aspect

The decorative film according to any one of the first to third aspects, having an elongation of 60% or greater and a strength at break of 50 N/25 mm or greater, as measured in accordance with JIS A 5759:2016 6.8.

### Fifth Aspect

The decorative film according to any one of the first to fourth aspects, wherein the colored acrylic pressure-sensitive adhesive layer contains an adhesive polymer having a glass transition temperature of −40° C. or lower.

### Sixth Aspect

The decorative film according to any one of the first to fifth aspects, wherein the colored acrylic pressure-sensitive adhesive layer contains a carboxy group-containing (meth)acrylic polymer and an amino group-containing (meth)acrylic polymer.

### Seventh Aspect

The decorative film according to any one of the first to sixth aspects, wherein the transparent top layer includes a topcoat layer on an opposite side of the colored acrylic pressure-sensitive adhesive layer of the transparent thermoplastic polyurethane elastomer film.

### Eighth Aspect

The decorative film according to any one of the first to seventh aspects, wherein a thickness of the decorative film is 240 μm or less.

### Ninth Aspect

The decorative film according to any one of the first to eighth aspects, wherein a total heat release for 20 minutes after start of heating as measured in accordance with ISO 5660-1 Heat Release Rate (cone calorimeter method) is 8 MJ/m² or less.

### Tenth Aspect

The decorative film according to any one of the first to ninth aspects, wherein the decorative film contains substantially no flame retardant.

### Eleventh Aspect

The decorative film according to any one of the first to tenth aspects, wherein, when a color difference ΔE* is measured from a side of the transparent top layer with the background color being white and black, the color difference ΔE* is 11 or less between a part of the white background color and a part of the black background color.

1. A decorative film comprising:
a transparent top layer including a transparent thermoplastic polyurethane elastomer film; and
a colored acrylic pressure-sensitive adhesive layer, wherein
the decorative film has a tensile strength at 2% strain of 20 N/25 mm or less and an elongation of 150% or greater.

2. The decorative film according to claim 1, wherein the transparent top layer has a total light transmittance of the transparent top layer in a wavelength range of 380 nm to 780 nm of 80% or greater.

3. The decorative film according to claim 1, wherein the transparent top layer and the colored acrylic pressure-sensitive adhesive layer are disposed adjacent to each other.

4. The decorative film according to claim 1, having an elongation of 60% or greater and a strength at break of 50 N/25 mm or greater, as measured in accordance with JIS A 5759:2016 6.8.

5. The decorative film according to claim 1, wherein the colored acrylic pressure-sensitive adhesive layer contains an adhesive polymer having a glass transition temperature of −40° C. or lower.

6. The decorative film according to claim 1, wherein the colored acrylic pressure-sensitive adhesive layer contains a carboxy group-containing (meth)acrylic polymer and an amino group-containing (meth)acrylic polymer.

7. The decorative film according to claim 1, wherein the transparent top layer includes a topcoat layer on an opposite side of the colored acrylic pressure-sensitive adhesive layer of the transparent thermoplastic polyurethane elastomer film.

8. The decorative film according to claim 1, wherein a thickness of the decorative film is 240 μm or less.

9. The decorative film according to claim 1, wherein a total heat release for 20 minutes after start of heating as measured in accordance with ISO 5660-1 Heat Release Rate (cone calorimeter method) is 8 MJ/m2 or less.

10. The decorative film according to claim 1, wherein the decorative film contains substantially no flame retardant.
